(19) United States
(12) Patent Application Publication
(10) Pub. No.: US 2015/0260917 A1
(43) Pub. Date: Sep. 17, 2015

(54) Optical Fiber Coupling Member and Manufacturing Method of The Same

(71) Applicant: KONICA MINOLTA, INC., Chiyoda-ku, Tokyo (JP)

(72) Inventors: Toshiyuki Imai, Hachioji-shi (JP); Fumio Nagai, Kunitachi-shi (JP)

(21) Appl. No.: 14/425,256

(22) PCT Filed: Aug. 28, 2013
(86) PCT No.: PCT/JP2013/073014

§ 371 Date: Mar. 2, 2015

(30) Foreign Application Priority Data
Aug. 29, 2012 (JP) 2012-188475

(51) Int. Cl. G02B 6/26; G02B 6/32; G02B 6/04; G02B 6/02

(52) U.S. Cl. CPC G02B 6/268; G02B 6/02042; G02B 6/32; G02B 6/04

(57) ABSTRACT

An optical fiber coupling member and a manufacturing method thereof are provided for reducing a decrease in the coupling efficiency upon coupling of a multi-core fiber with a fiber bundle. A coupling member includes one end in contact with a first optical waveguide that includes a bundle of single cores each covered with a cladding, another end in contact with a second optical waveguide that includes a plurality of cores each covered with a cladding, and a predetermined medium that fills between the one end and the other end. The optical fiber coupling member changes the mode field diameter of each of light rays incident from each optical path of the first optical waveguide. The optical fiber coupling member changes the intervals of the light rays, the mode field diameter of which has been changed, and guides the light rays to the cores of the second optical waveguide.

### TECHNICAL FIELD

The present invention relates to an optical fiber coupling member for coupling optical fibers used for optical communications and the like, and a manufacturing method of the optical fiber coupling member.

### BACKGROUND ART

The spread of mobile devices such as smartphones and tablet computers has created a need for data communication with a vast amount of information. Along with that, an increase is desired in the capacity of optical communications.

Conventional optical communications use a single-core fiber in which a core is encased in a cladding. However, when communication is performed with one single-core fiber, the capacity is so limited that there is a need for a technology to perform data communication with a capacity exceeding the limit.

In this regard, for example, a multi-core fiber can be used for such data communications. The multi-core fiber is an optical fiber in which a plurality of cores are provided in one cladding (see Patent Documents 1 and 2). Because of having a plurality of cores, the multi-core fiber is capable of data communications with higher capacity as compared to the single-core fiber.

In an example of optical communications, the multi-core fiber may be optically coupled with a fiber bundle for use. The fiber bundle is formed of a bundle of a plurality of single-core fibers.

### PRIOR ART DOCUMENT

### Patent Documents

[Patent Document 1] Japanese Unexamined Patent Application Publication No. Hei 10-104443

[Patent Document 2] Japanese Unexamined Patent Application Publication No. Hei 8-119656

### SUMMARY OF THE INVENTION

### Problems to be Solved by the Invention

For the optical coupling of a multi-core fiber with a bundle of single-core fibers, it is important to secure the coupling efficiency, that is, to reduce the coupling loss.

When multi-core fibers having the same number of cores are coupled together, the cores can be securely coupled together by the positioning of the multi-core fibers. In this case, the coupling loss hardly occurs, and thus enhanced coupling efficiency can be achieved.

On the other hand, when a multi-core fiber is coupled with a fiber bundle, the coupling efficiency reduces. For example, generally, the cores of the multi-core fiber are arranged at intervals narrower than the radius of each single-core fiber of the fiber bundle. Accordingly, upon coupling of the multi-core fiber with the fiber bundle, it is difficult to securely couple their cores together. This results in the reduction of the coupling efficiency between the multi-core fiber and the fiber bundle.

In addition, if a multi-core fiber is optically coupled with a fiber bundle via an air layer, a coupling loss may occur due to Fresnel reflection or the like. Hence, the coupling efficiency decreases between the multi-core fiber and the fiber bundle.

The present invention is directed at solving the above problems, and the object is to provide an optical fiber coupling member capable of reducing a decrease in the coupling efficiency when a multi-core fiber is coupled with a fiber bundle and a method for manufacturing the same.

### Means of Solving the Problems

To achieve the object mentioned above, an optical fiber coupling member as set forth in claim 1 has one end in contact with a first optical waveguide that includes a bundle of a plurality of single cores each covered with a cladding. Another end opposite to the one end is in contact with a second optical waveguide that includes a plurality of cores each covered with a cladding. The space between the one end and the other end of the coupling member is filled with a predetermined medium. The optical fiber coupling member changes the mode field diameter of light incident from the one end or the other end of the coupling member. The optical fiber coupling member changes the interval of the light, the mode field diameter of which has been changed, and guides the light to either each of the cores of the second optical waveguide or each of the cores of the first optical waveguide, which is located opposite the incident side from which the light is incident.

An optical fiber coupling member as set forth in claim 2 is the optical fiber coupling member of claim 1, further including a first optical system and a second optical system. The first optical system changes the mode field diameter of the light incident from the one end or the other end of the coupling member. The second optical system changes the interval of the light the mode field diameter of which has been changed.

An optical fiber coupling member as set forth in claim 3 is the optical fiber coupling member of claim 2, wherein the predetermined medium includes a first medium and a second medium having different refractive indices. The first optical system and the second optical system are located in the first medium. The first optical system includes a plurality of lenses which are formed of the second medium and arranged in an array. The second optical system includes lenses which are formed of the second medium and constitute a both-side telecentric optical system.

An optical fiber coupling member as set forth in claim 4 is the optical fiber coupling member of claim 3, wherein the second medium that forms the lenses in the first optical system is different from the second medium that forms the lenses in the second optical system.

An optical fiber coupling member as set forth in claim 5 is the optical fiber coupling member of claim 3 or 4, wherein the first medium has a refractive index identical to the refractive index of the cores of the first optical waveguide or that of the cores of the second optical waveguide.

An optical fiber coupling member as set forth in claim 6 is the optical fiber coupling member of claim 2, wherein the first optical system includes a plurality of first GRIN lenses as the predetermined medium. The first GRIN lenses are formed of a medium in which the refractive index is adjusted to change the mode field diameter of the light incident from the one end or the other end of the coupling member. The second optical system includes a second GRIN lens. The second GRIN lens is formed of a medium, as the predetermined medium, in which the refractive index is adjusted to change the interval of the light the mode field diameter of which has been changed.

An optical fiber coupling member as set forth in claim 7 is the optical fiber coupling member of claim 6, wherein the first GRIN lenses each include a first optical member that collimates light from an optical path and a second optical member that converges the light from the first optical member. The second GRIN lens includes a third optical member that collimates the light from the second optical member and a fourth optical member that converges the light from the third optical member.

An optical fiber coupling member as set forth in claim 8 is the optical fiber coupling member of claim 2, wherein the first optical system includes, as the predetermined medium, a plurality of fibers that change the mode field diameter of the light incident from the one end or the other end of the coupling member. The second optical system includes a second GRIN lens. The second GRIN lens is formed of a medium, as the predetermined medium, in which the refractive index is adjusted to change the interval of the light the mode field diameter of which has been changed.

An optical fiber coupling member as set forth in claim 9 is the optical fiber coupling member of any one of claims 2 to 8, wherein the first optical system and the second optical system are fixed together by an adhesive to be formed integrally.

An optical fiber coupling member as set forth in claim 10 is the optical fiber coupling member of any one of claims 1 to 9, further including a fitting portion and a fitted portion. The fitting portion is provided to an end surface of the first optical waveguide and/or the second optical waveguide. The fitted portion is provided to the one end and/or the other end of the coupling member, and is fitted in the fitting portion.

An optical fiber coupling member as set forth in claim 11 is the optical fiber coupling member of any one of claims 1 to 10, wherein the first optical waveguide is a fiber bundle including a plurality of single-core fibers as the single cores. The second optical waveguide is a multi-core fiber.

Further, in order to solve at least one of the above problems, a manufacturing method as set forth in claim 12 is a method of manufacturing an optical fiber coupling member that includes a first substrate, a second substrate, a third substrate, and a fourth substrate. The first substrate includes a plurality of first members. One end of the first members is in contact with a fiber bundle formed of a plurality of single-core fibers. The other end is provided with a plurality of first recesses each corresponding to one of the single-core fibers. The second substrate includes a plurality of second members. One end of the second members is provided with a plurality of second recesses corresponding to the first recesses. The other end is provided with a third recess corresponding to the second recesses. The third substrate includes a plurality of third members. One end of the third members is provided with a fourth recess corresponding to the third recess. The other end is provided with a fifth recess corresponding to the fourth recess. The fourth substrate includes a plurality of fourth members. One end of the fourth members is provided with a sixth recess corresponding to the fifth recess. The other end is in contact with a multi-core fiber. The manufacturing method includes stacking the first substrate and the second substrate in layers such that the first recesses face the second recesses. The manufacturing method further includes stacking the second substrate and the third substrate in layers such that the third recess faces the fourth recess. The manufacturing method further includes stacking the third substrate and the fourth substrate in layers such that the fifth recess faces the sixth recess. The manufacturing method further includes injecting resin into spaces formed by the first recesses and the second recesses to form first lens units. The manufacturing method further includes injecting resin into a space formed by the third recess and the fourth recess to form a second lens unit. The manufacturing method further includes injecting resin into a space formed by the fifth recess and the sixth recess to form a third lens unit. The manufacturing method further includes cutting layers of the substrates into individual pieces formed of the first to fourth members, after the first lens units, the second lens unit, and the third lens unit have been fabricated.

### Effects of the Invention

As described above, the optical fiber coupling member is filled with a predetermined medium. The optical fiber coupling member changes the mode field diameter of light rays incident from one end in contact with the first optical waveguide or the other end in contact with the second optical waveguide. The optical fiber coupling member changes the intervals of the light rays whose mode field diameter has been changed, and guides the light rays to either the cores of the second optical waveguide or the cores of the first optical waveguide, which are located opposite the incident side. With this, an air layer does not intervene between the first optical waveguide and the second optical waveguide. Thus, the optical fiber coupling member is capable of reducing a decrease in the coupling efficiency upon coupling of the multi-core fiber with the fiber bundle.

### BRIEF DESCRIPTION OF THE DRAWINGS

FIG. 1 is a view of a multi-core fiber common in all embodiments.

FIG. 2 is a view of a coupling member according to a first embodiment.

FIG. 3 is a flowchart of a method of manufacturing the coupling member of the first embodiment.

FIG. 4A is a view for explaining the method of manufacturing the coupling member of the first embodiment.

FIG. 4B is another view for explaining the method of manufacturing the coupling member of the first embodiment.

FIG. 4C is a still another view for explaining the method of manufacturing the coupling member of the first embodiment.

FIG. 4D is a still another view for explaining the method of manufacturing the coupling member of the first embodiment.

FIG. 4E is a still another view for explaining the method of manufacturing the coupling member of the first embodiment.

FIG. 4F is a still another view for explaining the method of manufacturing the coupling member of the first embodiment.

FIG. 4G is a still another view for explaining the method of manufacturing the coupling member of the first embodiment.

FIG. 4H is a still another view for explaining the method of manufacturing the coupling member of the first embodiment.

FIG. 5 is a view of a coupling member according to a second embodiment.

FIG. 6 is a view of a coupling member according to a third embodiment.

FIG. 7A is a view of a coupling member according to a modification 1.

FIG. 7B is a view of a multi-core fiber of the modification 1.

FIG. 7C is a view of the multi-core fiber and the coupling member of the modification 1.

### MODES FOR CARRYING OUT THE INVENTION

### [Structure of Multi-Core Fiber]

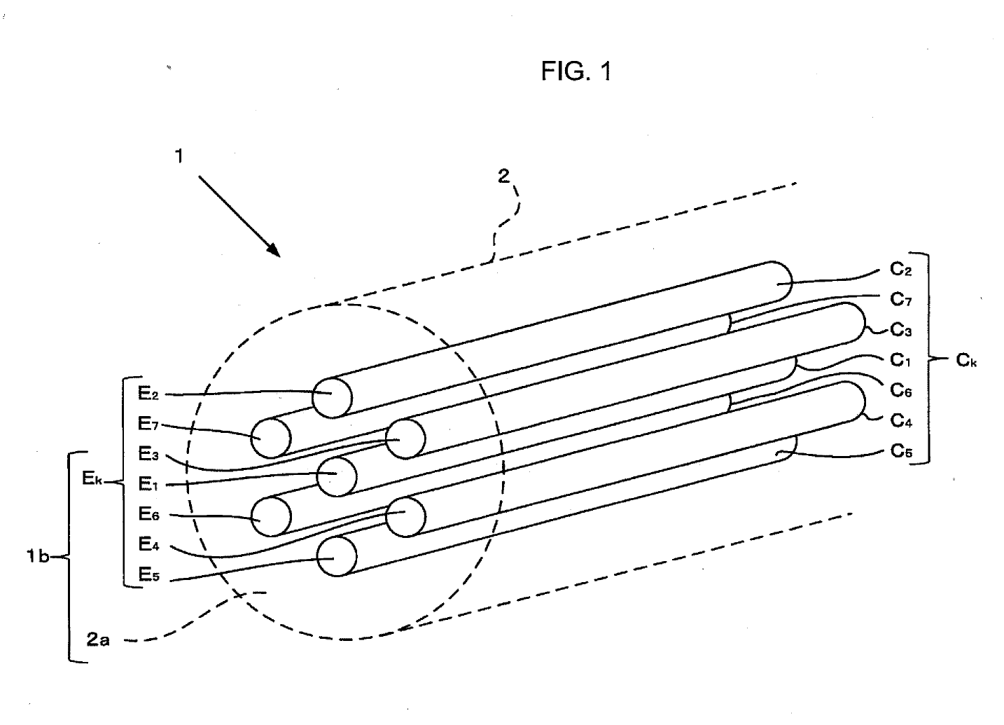

Referring to FIG. 1, a description is given of the structure of a multi-core fiber 1. The multi-core fiber 1 is generally a flexible elongated cylindrical member. FIG. 1 is a perspective view of the multi-core fiber 1. In FIG. 1, only the tip of the multi-core fiber 1 is illustrated.

The multi-core fiber 1 is formed of a material with high light transmissivity such as quartz glass, plastic, and the like. The multi-core fiber 1 includes a plurality of cores Cₖ (k=1 to n) and a cladding 2.

The cores Cₖ are transmission lines (optical paths) for transmitting light from a light source (not illustrated). Each of the cores Cₖ has an end surface Eₖ (k=1 to n). The end surface Eₖ radiates the light emitted from the light source. To achieve a higher refractive index than that of the cladding 2, for example, the cores Cₖ are formed of a material obtained by adding germanium oxide (GeO₂) to silica glass. Although FIG. 1 illustrates a structure including seven cores C₁ to C₇, the embodiment is not so limited, and at least two cores Cₖ may be sufficient.

The cladding 2 covers the cores Cₖ and thereby confines the light from the light source in the cores Cₖ. An end surface 2a of the cladding 2 and the end surfaces Eₖ of the cores Cₖ form the same plane (an end surface 1b of the multi-core fiber 1). The cladding 2 is made of a material having a lower refractive index than the material of the cores Cₖ. For example, when the cores Cₖ are made of quartz glass and germanium oxide, quartz glass is used as a material for the cladding 2. In this manner, by providing the cores Cₖ with a higher refractive index than the cladding 2, the light from the light source is totally reflected at the boundary surface between the cladding 2 and the cores. Cₖ. With this, the light can be transmitted in the cores Cₖ.

### First Embodiment

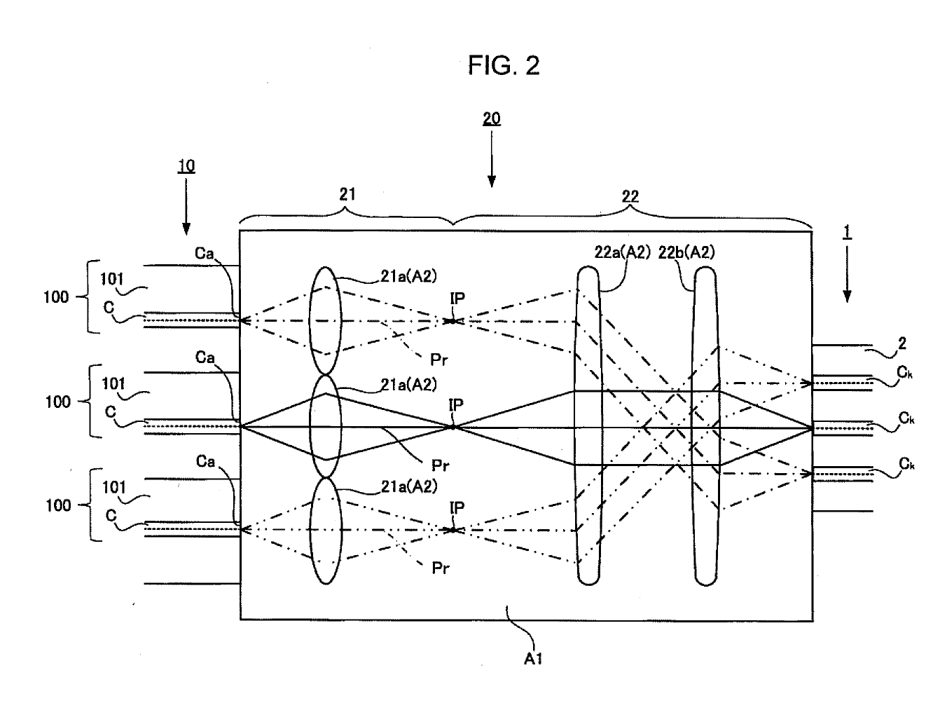

Next, a description is given of the structure of a coupling member 20 and the manufacturing method thereof according to a first embodiment with reference to FIGS. 2 to 4H. The coupling member 20 is located between a first optical waveguide and a second optical waveguide. The first optical waveguide is formed of a bundle of a plurality of single cores (optical paths) each covered with a cladding. The second optical waveguide is formed of a plurality of cores each covered with a cladding. The coupling member 20 optically couples the first optical waveguide and the second optical waveguide together. The coupling member 20 of the embodiment optically couples a fiber bundle 10 as the first optical waveguide with the multi-core fiber 1 as the second optical waveguide. FIG. 2 is a conceptual diagram illustrating an axial cross-section of the coupling member 20, the fiber bundle 10, and the multi-core fiber 1.

### [Structure of Fiber Bundle]

The fiber bundle 10 includes a plurality of single-core fibers 100. The number of the single-core fibers 100 corresponds to the number of cores in the multi-core fiber 1 to be coupled with the fiber bundle 10 by the coupling member 20. In the example of FIG. 1, the multi-core fiber 1 has seven cores, and the fiber bundle 10 is formed of a bundle of as many of the single-core fibers 100 as the cores, i.e., seven. FIG. 2 illustrates only three of the single-core fibers 100. The single-core fibers 100 each include a core C encased in a cladding 101. The core C is a transmission line for transmitting the light from the light source. The light emitted from an end surface Ca of the core C is incident to one end of the coupling member 20. The single-core fibers 100 correspond to an example of “single cores each covered with a cladding”.

### [Structure of Coupling Member]

The coupling member 20 of the embodiment has the one end in contact with the fiber bundle 10 and the other end in contact with the multi-core fiber 1. The coupling member 20 is filled with a predetermined medium. The predetermined medium is not air, and may be, for example, silica glass, BK7, ultraviolet (UV) curable resin, thermosetting resin, or the like. The fiber bundle 10 and the multi-core fiber 1 are fixed to the coupling member 20 by an adhesive or the like at their respective end surfaces facing the coupling member 20. That is, one end of the coupling member 20 is fixed to the end surface of the fiber bundle 10, while the other end is fixed to the end surface of the multi-core fiber 1. The adhesive has a similar refractive index to that of the core C (the cores Cₖ).

The coupling member 20 changes the mode field diameter of light incident from each optical path (the single-core fibers 100) of the fiber bundle 10. The coupling member 20 changes the intervals of rays of the light with a changed mode field diameter. Then, the light is guided to each core (the cores Cₖ) of the multi-core fiber 1. The term “mode field diameter” as used herein refers to the diameter of the light that is actually emitted from a certain object. For example, the light passing through the core C of the single-core fibers 100 leaks a little in the cladding 101 side surrounding the core C. Accordingly, the light emitted from the single-core fibers 100 comes from not only the core C but also from the cladding 101 that surrounds the core C. This means that the light emitted from the single-core fibers 100 has a diameter larger than the diameter of the core C. “The diameter of the light emitted from the single-core fibers 100” is an example of the mode field diameter.

The coupling member 20 of the embodiment includes a first optical system 21 and a second optical system 22. The first optical system 21 changes the mode field diameter of light incident from each of the single-core fibers 100 and guides the light to the second optical system 22. The second optical system 22 changes the interval between rays of the light incident from the first optical system 21 to match it with the interval of the cores Cₖ of the multi-core fiber 1. Incidentally, a medium A2 that forms the lens part of the first optical system 21 and the second optical system 22 has a different refractive index than a medium A1 that forms other parts. The medium A1 corresponds to an example of “first medium”. The medium A2 corresponds to an example of “second medium”. In this embodiment, the first optical system 21 and the second optical system 22 are integrally formed via the medium A1. That is, the first optical system 21 and the second optical system 22 are formed continuously.

Preferably, the medium A1 has the same refractive index as that of the core C of the single-core fibers 100 or the cores Cₖ of the multi-core fiber 1. For example, when the cores Cₖ of the multi-core fiber 1 are made of a material obtained by adding germanium oxide (GeO₂) to silica glass, the medium A1 may be made of the same material. Alternatively, the medium A1 may be made of a different material having a similar refractive index as that of the cores Cₖ. By providing the medium A1 and the core C with the same refractive index, light loss can be reduced in the medium A1. In other words, it is possible to reduce a decrease in the coupling efficiency of light. Besides, preferably, the difference between the refractive index of the medium A1 and that of the core C (or the cores Cₖ) is within 2%. If the difference in the refractive index is within 2%, reflection at the boundary surface between the coupling member 20 and the single-core fibers 100 (or the multi-core fiber 1) is around 40 dB. Thus, light loss can be reduced in optical transmission.

The first optical system 21 of the embodiment enlarges the mode field diameter of light from each of the single-core fibers 100 of the fiber bundle 10. The first optical system 21 includes, for example, a plurality of convex lens units 21a that are arranged in an array. The convex lens units 21a are formed of the medium A2, and arranged in the medium A1. The convex lens units 21a are provided as many as the single-core fibers 100 included in the fiber bundle 10 to change the mode field diameter of every light from the fiber bundle 10. In this embodiment, the number of the convex lens units 21a is seven. The first optical system 21 (the convex lens units 21a) is located in a position where a principal ray Pr of light emitted from each of the end surfaces Ca of the fiber bundle 10 is vertically incident to the surface of corresponding one of the convex lens units 21a. That is, the convex lens units 21a are each located on the same optical axis as corresponding one of the cores C. The convex lens units 21a have a diameter larger than the mode field diameter of the cores C, and collect light from the cores C. The convex lens units 21a of the embodiment are an example of “a plurality of lenses”.

The second optical system 22 of the embodiment is a reduction optical system that narrows the interval of a plurality of light rays, the mode field diameter of which has been enlarged by the first optical system 21, and guides the light rays to the cores C₁ to C₇ of the multi-core fiber 1. The second optical system 22 is formed of a both-side telecentric optical system including two convex lens units (a convex lens unit 22a, a convex lens unit 22b). The convex lens units 22a and 22b are formed of the medium A2, and arranged in the medium A1. Only a pair of the convex lens units 22a and 22b is provided to change the interval of light incident from a plurality of the convex lens units 21a. The second optical system 22 is located in such a position that the principal ray Pr of each light from the first optical system 21 is vertically incident to the end surface Eₖ of corresponding one of the cores Cₖ of the multi-core fiber 1. Incidentally, the medium A2 that forms the convex lens units 21a in the first optical system 21 may be different from the medium A2 that forms the convex lens units (the convex lens units 22a and 22b) in the second optical system 22.

To reduce the coupling loss of light, preferably, the mode field diameter of light from the single-core fibers 100 (the core C) is equal to the mode field diameter of light incident to the cores Cₖ of the multi-core fiber 1. Meanwhile, the second optical system 22 (the convex lens units 22a and 22b) is an optical system that narrows the interval of light. More specifically, the light that has passed through the convex lens units 22a and 22b has a reduced mode field diameter. Therefore, the first optical system 21 is preferably an enlarged optical system taking into account the magnification at which the mode field diameter is reduced by the second optical system 22, that is, the magnification at which the mode field diameter is reduced to match the mode field diameter of the cores Cₖ.

### [Travel of Light]

In the following, a description is given of how light travels through the coupling member 20 of the embodiment with reference to FIG. 2. In the embodiment, an example is described in which light is emitted from the fiber bundle 10.

First, light is emitted from the end surface Ca of the core C provided in each of the single-core fibers 100. The light emitted from the end surface Ca travels while being scattered in the medium A1 and is incident to corresponding one of the convex lens units 21a with a predetermined mode field diameter. As described above, in the embodiment, the principal ray Pr of the light emitted from the end surface Ca is vertically incident to each of the convex lens units 21a. The light passing through each of the convex lens units 21a forms an image at an imaging point IP as having an enlarged mode field diameter.

The light passing through each of the convex lens units 21a travels while being scattered in the medium A1 using the imaging point IP as a secondary light source and is incident to the convex lens unit 22a.

The convex lens units 22a and 22b are formed as a both-side telecentric optical system. Accordingly, the principal ray Pr of the light vertically incident to the convex lens unit 22a passes through the medium A1 while being collimated, and incident to the convex lens unit 22b. The principal rays Pr of the light are emitted vertically from the convex lens unit 22b at narrowed intervals. The principal rays Pr pass through the medium A1 and are vertically incident to the cores Cₖ of the multi-core fiber 1. In this manner, even if the mode field diameter and the interval of light (the principal rays Pr) are changed to obtain matching between the single-core fibers 100 and the multi-core fiber 1, when the light travels through the media A1 and A2, reflection or the like due to an air layer does not occur. Thus, the coupling member 20 having the structure of the embodiment is capable of reducing a decrease in the coupling efficiency.

With the structure of the coupling member 20 as described above, light emitted from the multi-core fiber 1 (the cores Cₖ) can also be guided to corresponding one of the single-core fibers 100 in the fiber bundle 10. More specifically, the coupling member 20 may change the interval of light rays emitted from the cores of the second optical waveguide (the multi-core fiber 1), then change the mode field diameter of each of the light rays the interval of which has been changed, and guide them to their respective optical paths (the single-core fibers 100) of the first optical waveguide (the fiber bundle 10).

In this case, the second optical system 22 extends the interval between a plurality of light rays emitted from the multi-core fiber 1. The first optical system 21 reduces the mode field diameter of the light rays from the second optical system 22. The light rays (the principal rays Pr) with a reduced mode field diameter are each vertically incident to the end surface Ca of corresponding one of the cores C.

The coupling member 20 may be made by combining the first optical system 21 and the second optical system 22 fabricated separately. Specifically, the first optical system 21 and the second optical system 22 are fabricated with the media A1 and A2. Then, an end surface of the first optical system 21 and an end surface of the second optical system 22 are fixed together by an adhesive to thereby form the coupling member 20. Here, the adhesive has a similar refractive index to that of the medium A1 (the medium A2).

### [Manufacturing Method of Coupling Member]

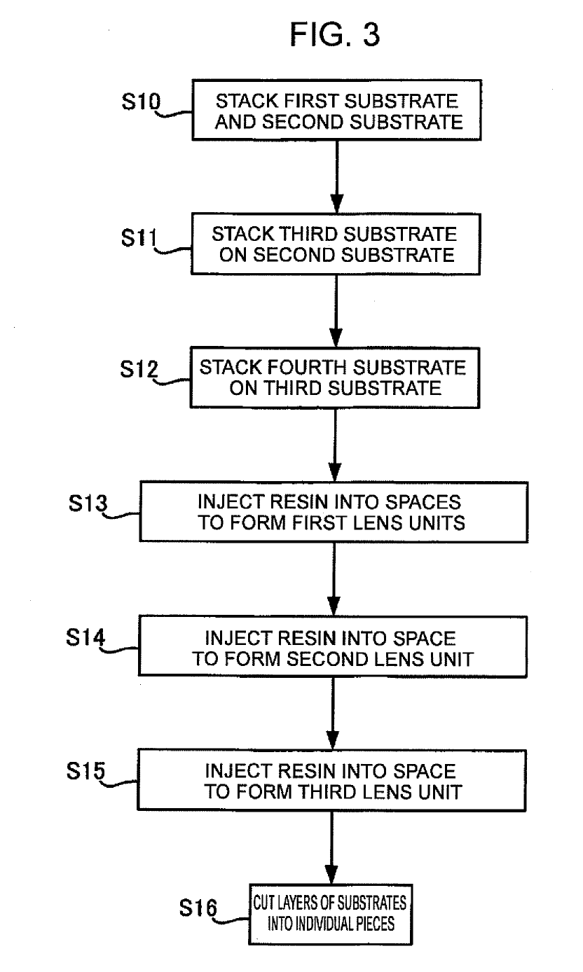

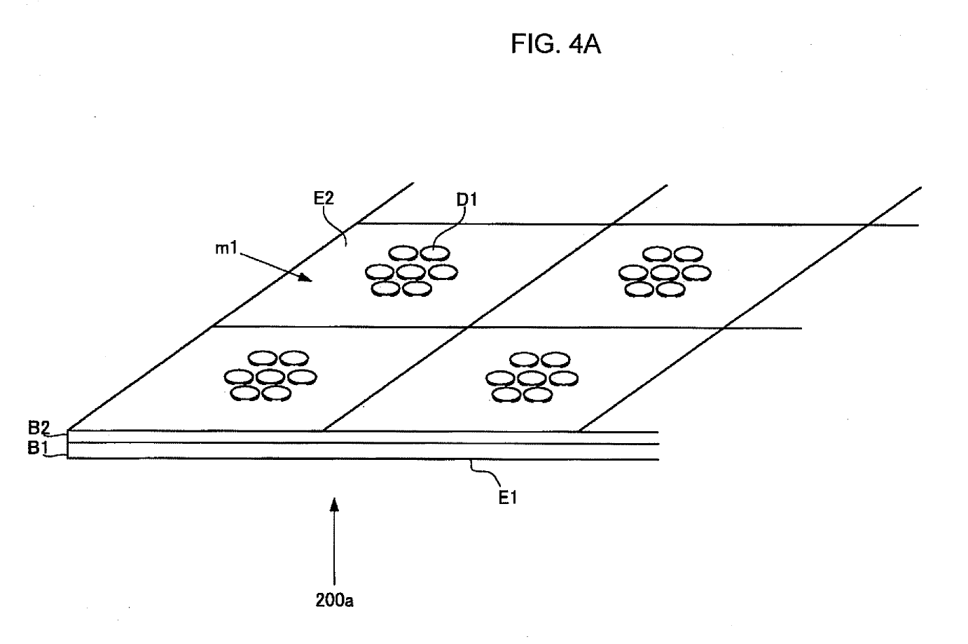

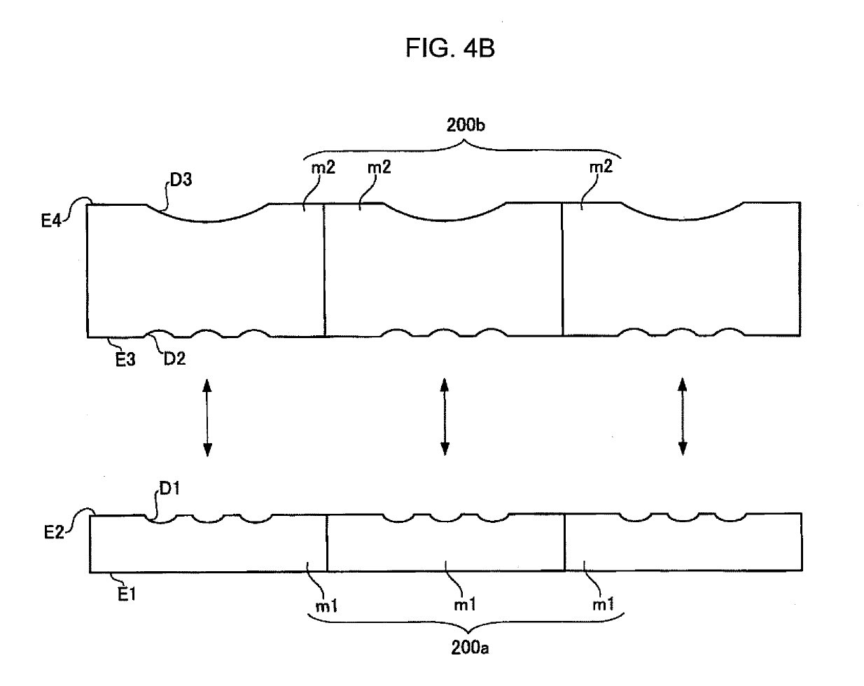

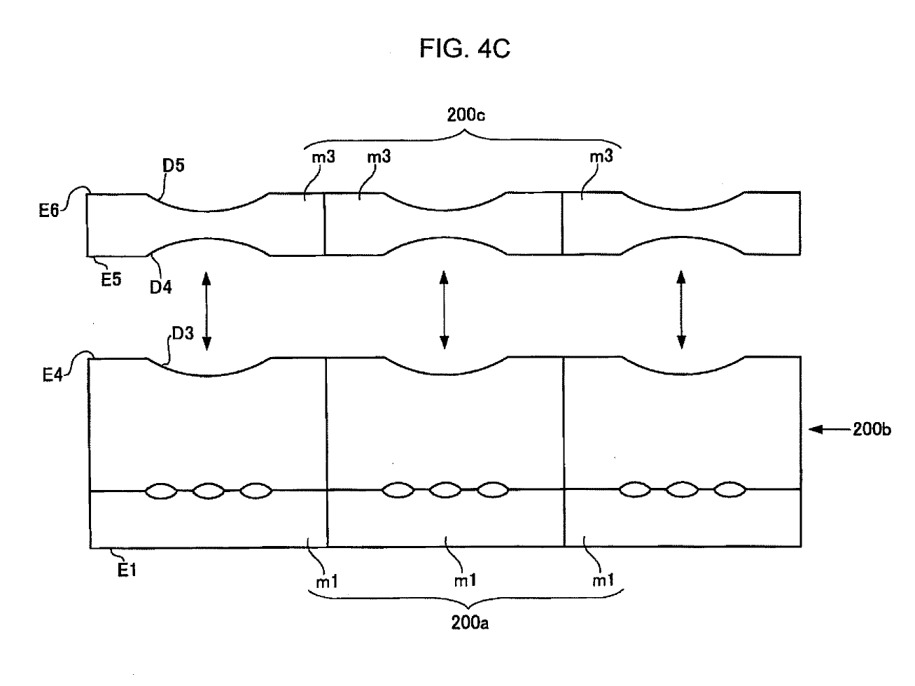

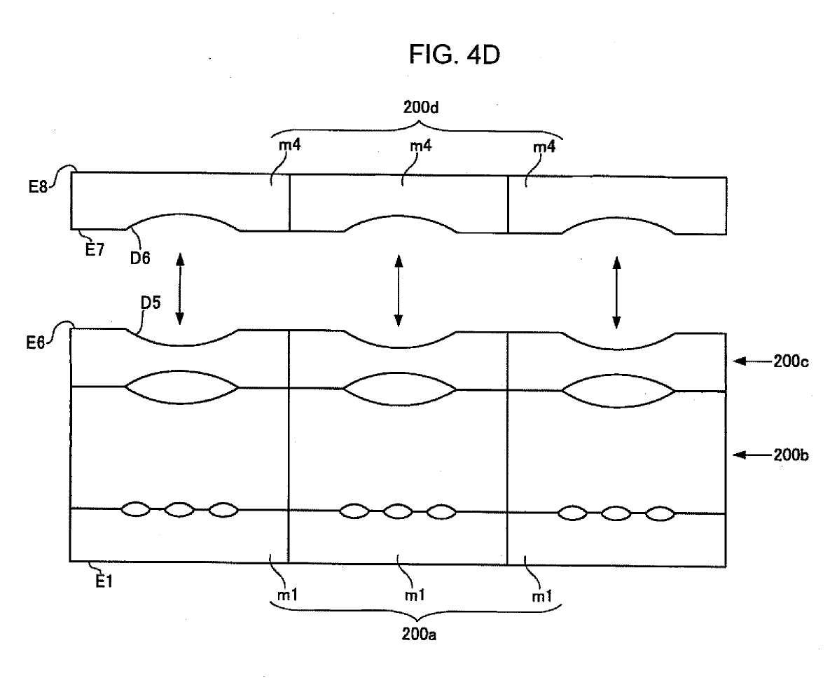

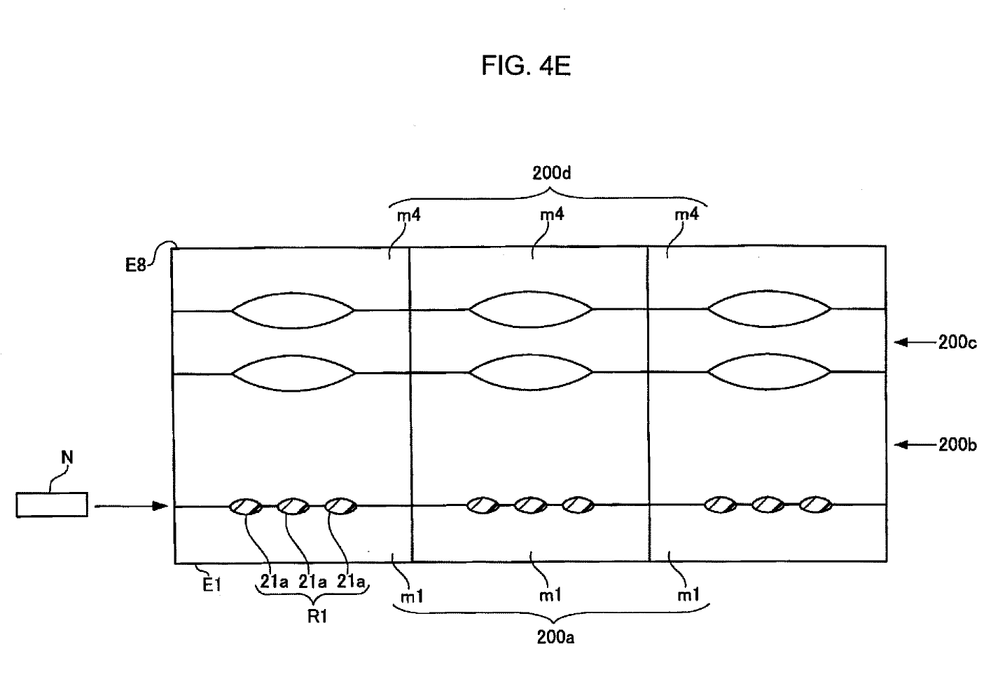

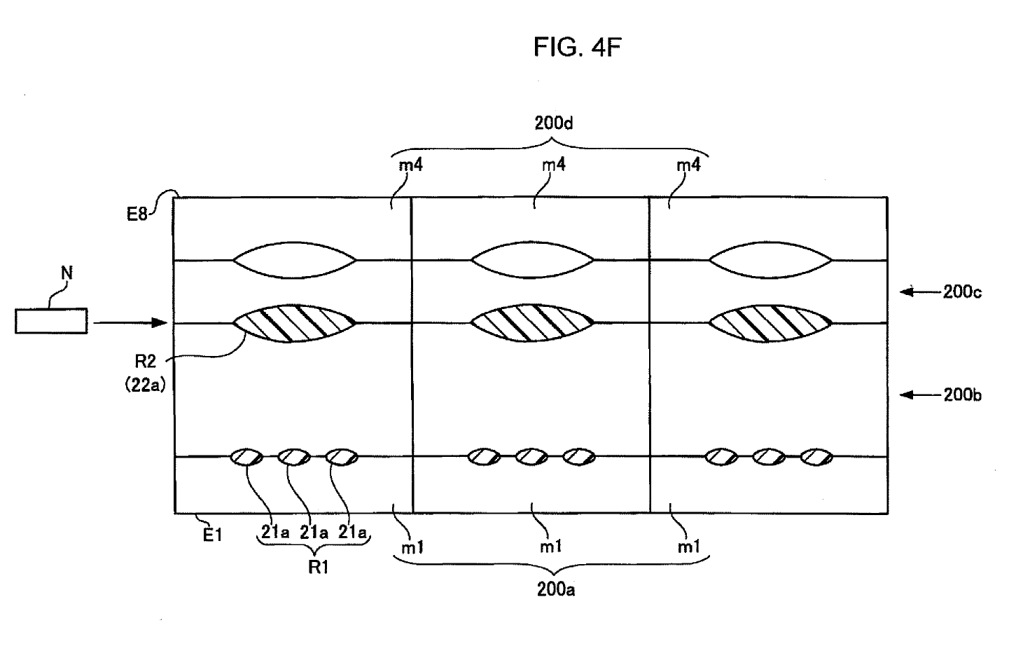

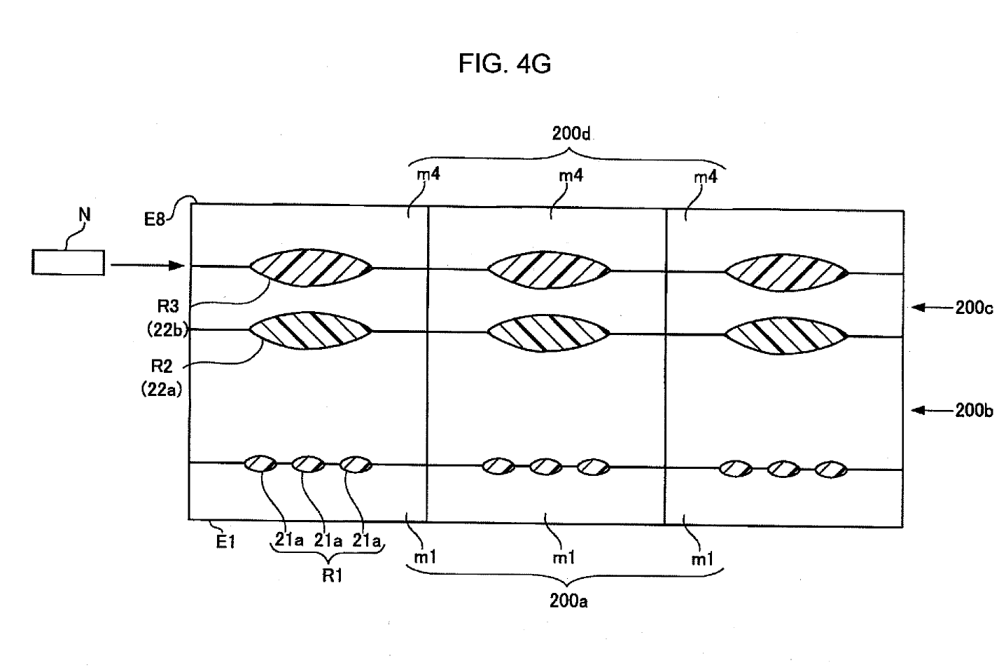

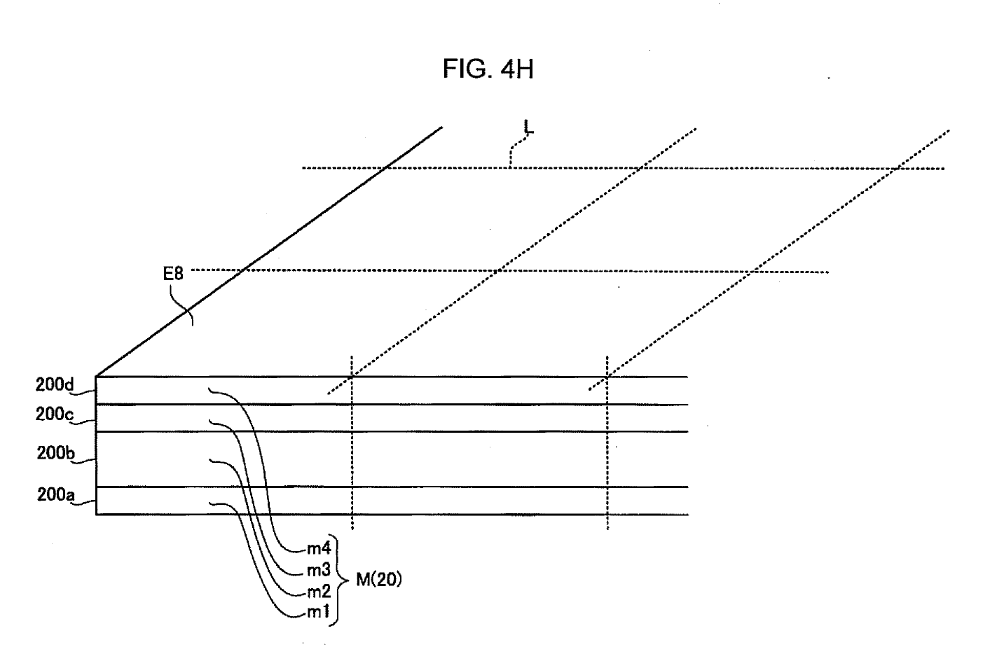

Next, referring to FIGS. 3 to 4H, a description is given of the manufacturing method of the coupling member 20 according to the embodiment. FIG. 3 is a flowchart of the manufacturing method of the coupling member 20. FIG. 4A is a perspective view of a first substrate 200a. In FIG. 4A, only a part of the first substrate 200a is illustrated. FIG. 4B is a schematic cross-sectional view of the first substrate 200a and a second substrate 200b. In FIG. 4B, only a part of the first substrate 200a and the second substrate 200b is illustrated. FIG. 4C is a schematic cross-sectional view of the first substrate 200a, the second substrate 200b, and a third substrate 200c. In FIG. 4C, only a part of the first substrate 200a, the second substrate 200b, and the third substrate 200c is illustrated. FIGS. 4D to 4G are schematic cross-sectional views of the first substrate 200a, the second substrate 200b, the third substrate 200c, and a fourth substrate 200d. In FIGS. 4D to 4G, only a part of the first substrate 200a, the second substrate 200b, the third substrate 200c, and the fourth substrate 200d is illustrated. FIG. 4H is a perspective view of layers of the first to fourth substrates 200a to 200d. In FIG. 4H, only a part of the first to fourth substrates 200a to 200d is illustrated. Note that the first to fourth substrates 200a to 200d are formed of the medium A1.

As illustrated in FIG. 4A, the first substrate 200a includes a plurality of first members m1 each having one end E1 and another end E2. The end E1 is in contact with the fiber bundle 10. The end E2 is provided with a plurality of first recesses D1 formed therein, each of which corresponds to one of the single-core fibers 100.

As illustrated in FIG. 4B, the second substrate 200b includes a plurality of second members m2 each having one end E3 and another end E4. The end E3 is provided with a plurality of second recesses D2 formed therein, which correspond to the first recesses D1. The end E4 is provided with a third recess D3 formed therein, which corresponds to the second recesses D2.

As illustrated in FIG. 4C, the third substrate 200c includes a plurality of third members m3 each having one end E5 and another end E6. The end E5 is provided with a fourth recess D4 formed therein, which corresponds to the third recess D3. The end E6 is provided with a fifth recess D5 formed therein, which corresponds to the fourth recess D4.

As illustrated in FIG. 4D, the fourth substrate 200d includes a plurality of fourth members m4 each having one end E7 and another end E8. The end E7 is provided with a sixth recess D6 formed therein, which corresponds to the fifth recess D5. The end E8 is in contact with the multi-core fiber 1.

For the manufacture of the first to fourth substrates 200a to 200d, for example, the method described in International Publication WO 2010/032511 can be applicable. Taking the first substrate 200a as an example, a resin portion B2 (see FIG. 4A) is formed on the surface of a main body B1 (see FIG. 4A) that is made of the medium A1. The resin portion B2 is made of the same resin as the medium A1. Then, the first recesses D1 are formed in the resin portion B2 with a master mold (not illustrated). Alternatively, glass nanoimprint lithography can be applied to manufacture the first to fourth substrates 200a to 200d. In other words, the first recesses D1 may be directly formed in the main body B1 that is made of the medium A1.

In the following, a description is given of the manufacturing method of the coupling member 20 of the embodiment. First, a manufacturing apparatus (not illustrated) stacks the first substrate 200a and the second substrate 200b in layers (S10; see FIG. 4B). Specifically, the manufacturing apparatus arranges the first substrate 200a and the second substrate 200b so that the first recesses D1 face the second recesses D2. The manufacturing apparatus then stacks the first substrate 200a and the second substrate 200b as arranged above in layers (see FIG. 4B). The first recesses D1 and the second recesses D2 form a plurality of spaces (gaps) between the first substrate 200a and the second substrate 200b.

The manufacturing apparatus stacks the third substrate 200c on the second substrate 200b (S11). Specifically, the manufacturing apparatus arranges the third substrate 200c and the unit fabricated in step S10 such that the third recess D3 formed in the end E4 of the second substrate 200b faces the fourth recess D4 formed in the end E5 of the third substrate 200c. Thereafter, the manufacturing apparatus stacks the third substrate 200c on the second substrate 200b as arranged above in layers (see FIG. 4C). The third recess D3 and the fourth recess D4 form a space (gap) between the second substrate 200b and the third substrate 200c.

The manufacturing apparatus stacks the fourth substrate 200d on the third substrate 200c (S12). Specifically, the manufacturing apparatus arranges the fourth substrate 200d and the unit fabricated in step S11 such that the fifth recess D5 formed in the end E6 of the third substrate 200c faces the sixth recess D6 formed in the end E7 of the fourth substrate 200d. The manufacturing apparatus then stacks the fourth substrate 200d on the third substrate 200c as arranged above in layers (see FIG. 4D). The fifth recess D5 and the sixth recess D6 form a space (gap) between the third substrate 200c and the fourth substrate 200d. The substrates are bonded together as stacked in layers. At this time, the position of the substrates can be adjusted by, for example, an alignment mark provided on each substrate.

The manufacturing apparatus injects resin through a nozzle N into the spaces formed by the first recesses D1 and the second recesses D2 to form first lens units R1 (S13; see FIG. 4E). In this embodiment, the resin to be injected is the medium A2. The first lens units R1 in each piece of the members are formed of the convex lens units 21a.

The manufacturing apparatus injects resin through the nozzle N into the space formed by the third recess D3 and the fourth recess D4 to form a second lens unit R2 (S14; see FIG. 4F). In this embodiment, the resin to be injected is the medium A2. The second lens unit R2 in each piece of the members is formed of the convex lens unit 22a.

The manufacturing apparatus injects resin through the nozzle N into the space formed by the fifth recess D5 and the sixth recess D6 to form a third lens unit R3 (S15; see FIG. 4G). In this embodiment, the resin to be injected is the medium A2. The third lens unit R3 in each piece of the members is formed of the convex lens unit 22b. The unit fabricated until step S15 is then tested at once to check manufacturing errors and the like.

After step S15, the manufacturing apparatus cuts the layers of the substrates into individual pieces M (S16; see FIG. 4H). In FIG. 4H, broken lines L indicate lines to be cut. In further detail, after fabricating the first lens units R1, the second lens unit R2, and the third lens unit R3, the manufacturing apparatus cuts the first to fourth substrates 200a to 200d into the individual pieces M formed of the first to fourth members m1 to m4. Each unit is tested individually. Each of the individual units (the pieces M) corresponds to the coupling member 20.

Various methods may be used for the resin injection (resin filling) in steps S13 to S15. For example, the technique described in International Publication WO 2011-055655 may be applicable. For another example, while the layers of the substrates (the first to fourth substrates 200a to 200d) illustrated in FIG. 4E are rotated 90 degrees, the nozzle N is placed beneath the spaces formed by the first recesses D1 and the second recesses D2. Then, the nozzle N injects resin from the lower side to the upper side of the space. With this, the spaces can be filled with the resin while the air is being evacuated therefrom. Thus, the resin can fill the spaces with no air voids. For still another example, with a pressure reducing device provided on the side opposite to the resin injection side, resin injection may be performed while the pressure in the spaces is being reduced. With this, the spaces can be filled with the resin without air entrapment.

Besides, the medium injected into the spaces through the nozzle N is not limited to the resin. For example, glass or the like having a softening point lower than that of the substrates and a low viscosity may be used in place of the resin. The “low viscosity” refers to the viscosity enough to fill the spaces.

The manufacturing method of the coupling member 20 is not limited to the above examples. For example, the manufacturing apparatus stacks the first substrate 200a and the second substrate 200b in layers (S10). Then, the manufacturing apparatus injects resin through the nozzle N (S13). Next, the manufacturing apparatus stacks the third substrate 200c on the second substrate 200b (S11). Thereafter, the manufacturing apparatus injects resin through the nozzle N (S14). Finally, the manufacturing apparatus stacks the fourth substrate 200d on the third substrate 200c (S12). After that, the manufacturing apparatus injects resin through the nozzle N (S15). That is, the manufacturing apparatus may fabricate the coupling member 20 by performing the step of injecting resin (the medium A2) into the spaces each time one substrate is stacked on another.

### [Operation and Effect]

Described below are the operation and effects of the embodiment.

According to the embodiment, one end of the coupling member 20 is the first optical waveguide (the fiber bundle 10) formed of a bundle of a plurality of single cores (the single-core fibers 100) each covered with a cladding. The other end of the coupling member 20 is in contact with the second optical waveguide (the multi-core fiber 1) formed of a plurality of cores each covered with a cladding. The space between the one end and the other end of the coupling member is filled with a predetermined medium. With respect to each light incident from one end or the other of the coupling member 20, the mode field diameter is changed. The interval of the light with a changed mode field diameter is also changed. The light is guided to the cores Cₖ of the multi-core fiber 1 or the single-core fibers 100 in the fiber bundle 10, which is located opposite side of the coupling member 20 to the incident side on which the light is incident.

With the above structure, the intervention of an air layer between the fiber bundle 10 and the multi-core fiber 1 can be avoided. Therefore, it is possible to reduce a decrease in the coupling efficiency upon coupling of the fiber bundle 10 with the multi-core fiber 1.

More specifically, the coupling member 20 includes the first optical system 21 and the second optical system 22. For example, the first optical system 21 changes the mode field diameter of light incident from each of the single-core fibers 100. The second optical system 22 changes the interval of the light with a changed mode field diameter.

Further, the medium includes a first medium (the medium A1) and a second medium (the medium A2) having different refractive indices. The first optical system 21 includes a plurality of lenses (the convex lens units 21a) formed of the second medium, which are arranged in an array in the first medium. In the second optical system 22, lenses (the convex lens unit 22a, the convex lens unit 22b), which are formed of the second medium and constitute a both-side telecentric optical system, are located in the first medium.

Thus, the coupling member 20 that is filled with the media A1 and A2 changes the mode field diameter of light incident from, for example, each of the single-core fibers 100 by the convex lens units 21a. The coupling member 20 changes the interval of the light with a changed mode field diameter by the both-side telecentric optical system (the convex lens units 22a and 22b), and guides the light to the cores Cₖ of the multi-core fiber 1. Accordingly, the intervention of an air layer between the fiber bundle 10 and the multi-core fiber 1 can be avoided. Therefore, it is possible to reduce a decrease in the coupling efficiency upon coupling of the fiber bundle 10 with the multi-core fiber 1. Moreover, since the coupling member 20 is integrally formed of the medium, the downsizing can be achieved.

Further, in the coupling member 20 of the embodiment, the refractive index of the first medium (the medium A1) is equal to or substantially equal to the refractive index of the core C in the single-core fibers 100 or that of the cores Cₖ in the multi-core fiber 1. Preferably, the difference in the refractive index between the first medium and the core C (the cores Cₖ) is within 2% to reduce the optical loss.

With the medium A1 formed of the same material as cores (the core C or the cores Cₖ) for transmitting light as described above, light from the cores is incident to the convex lens units 21a and the like while maintaining the light amount. That is, with the coupling member 20 of the embodiment, it is possible to further reduce a decrease in the coupling efficiency of light.

The manufacturing method of the embodiment enables the fabrication of the coupling member 20. The manufacturing method includes stacking the first substrate 200a and the second substrate 200b in layers.

The first substrate 200a includes a plurality of the first members m1 each having the end E1 and the end E2. The end E1 is in contact with the fiber bundle 10. The end E2 is provided with a plurality of the first recesses D1 formed therein, each of which corresponds to one of the single-core fibers 100.

The second substrate 200b includes a plurality of the second members m2 each having the end E3 and the end E4. The end E3 is provided with a plurality of the second recesses D2 formed therein, which correspond to the first recesses D1. The end E4 is provided with the third recess D3 formed therein, which corresponds to the second recesses D2. In this stacking, the first substrate 200a and the second substrate 200b are stacked in layers such that the first recesses D1 face the second recesses D2.

The manufacturing method further includes stacking the second substrate 200b and the third substrate 200c in layers. The third substrate 200c includes a plurality of the third members m3 each having the end E5 and the end E6. The end E5 is provided with the fourth recess D4 formed therein, which corresponds to the third recess D3. The end E6 is provided with the fifth recess D5 formed therein, which corresponds to the fourth recess D4. In this stacking, the second substrate 200b and the third substrate 200c are stacked in layers such that the third recess D3 faces the fourth recess D4.

The manufacturing method further includes stacking the third substrate 200c and the fourth substrate 200d in layers. The fourth substrate 200d includes a plurality of the fourth members m4 each having the end E7 and the end E8. The end E7 is provided with the sixth recess D6 formed therein, which corresponds to the fifth recess D5. The end E8 is in contact with the multi-core fiber 1 while the fifth recess D5 and the sixth recess D6 face each other.

The manufacturing method further includes injecting resin into spaces formed by the first recesses D1 and the second recesses D2 to form the first lens units R1. The manufacturing method further includes injecting resin into a space formed by the third recess D3 and the fourth recess D4 to form the second lens unit R2. The manufacturing method further includes injecting resin into a space formed by the fifth recess D5 and the sixth recess D6 to form the third lens unit R3. The manufacturing method further includes cutting layers of the substrates into individual pieces M formed of the first to fourth members m1 to m4, after the first lens units R1, the second lens unit R2, and the third lens unit R3 have been fabricated.

With the use of the manufacturing method as above, a plurality of coupling members (20) can be easily manufactured at once. Besides, since the lenses have a small diameter and are very thin, it is difficult to fabricate each of them alone. With this manufacturing method, however, the fabrication of the lenses can be facilitated. In other words, the small coupling member 20 can be easily manufactured.

### Second Embodiment

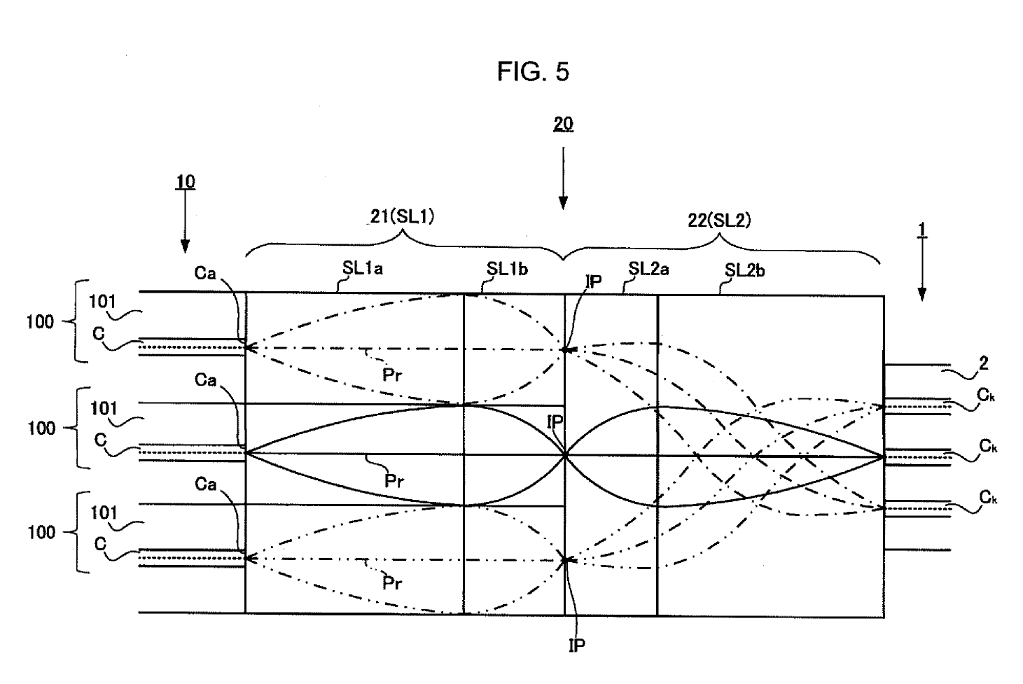

In the following, a description is given of the structure of the coupling member 20 according to a second embodiment with reference to FIG. 5. FIG. 5 is a conceptual diagram of an axial cross-section of the coupling member 20, the fiber bundle 10, and the multi-core fiber 1 of the second embodiment. In this embodiment, an example is described in which a GRIN lens is used for the first optical system 21 and the second optical system 22 that constitute the coupling member 20. Note that, regarding the same structure as in the first embodiment, the detailed description is omitted.

### [Structure of Coupling Member]

The coupling member 20 of the embodiment includes a GRIN lens. The GRIN lens is a refractive index distributed lens that has a refractive index distribution created and adjusted by ion exchange on the medium that constitutes the lens, and thereby bends scattering light to collect the light. That is, the GRIN lens can create a variation of refractive index by the ion exchange. As the GRIN lens, for example, a SELFOC lens (“SELFOC” is a registered trademark) may be used.

The first optical system 21 includes GRIN lenses SL1. The GRIN lenses SL1 are formed of a medium in which the refractive index is adjusted to change the mode field diameter of light incident from the fiber bundle 10 (the single-core fibers 100). In the embodiment, the GRIN lenses SL1 are provided to correspond to the number of the single-core fibers 100 that constitute the fiber bundle 10. The GRIN lenses SL1 are an example of “first GRIN lens”.

In the embodiment, the GRIN lenses SL1 includes first optical members SL1a and second optical members SL1b. The first optical members SL1a have one end in contact with the fiber bundle 10. The refractive index profile of the first optical members SL1a is adjusted to collimate scattering light incident from the single-core fibers 100. The second optical members SL1b have one end in contact with the other end of the first optical members SL1a. The refractive index profile of the second optical members SL1b is adjusted to converge the light collimated by the first optical members SL1a. The mode field diameter of the light converged by the second optical members SL1b (the light at the imaging point IP) is enlarged as compared to the mode field diameter of light from the single-core fibers 100. The first optical members SL1a and the second optical members SL1b are fixed together by an adhesive or the like, and thereby constitute the integrated GRIN lenses SL1. The adhesive has a similar refractive index to the medium.

The second optical system 22 includes a GRIN lens SL2. The GRIN lens SL2 is formed of a medium in which the refractive index is adjusted to change the interval of light whose mode field diameter has been changed. In the embodiment, only the one GRIN lens SL2 is provided so that light is incident from the GRIN lenses SL1. The GRIN lens SL2 is an example of “second GRIN lens”.

In the embodiment, the GRIN lens SL2 includes a third optical member SL2a and a fourth optical member SL2b. The third optical member SL2a has one end in contact with the other end of the second optical members SL1b. The refractive index profile of the third optical member SL2a is adjusted to collimate light from each of the second optical members SL1b. The fourth optical member SL2b has one end in contact with the other end of the third optical member SL2a. The other end of the fourth optical member SL2b is in contact with the multi-core fiber 1. The refractive index profile of the fourth optical member SL2b is adjusted to converge the light from the third optical member SL2a. The light converged by the fourth optical member SL2b is incident to corresponding one of the cores Cₖ of the multi-core fiber 1. The third optical member SL2a and the fourth optical member SL2b are fixed together by an adhesive or the like, and thereby constitute the integrated GRIN lens SL2. Then, the second optical members SL1b and the third optical member SL2a are fixed together by adhesive or the like, and thus the coupling member 20 is formed integrally.

As described in the first embodiment, to reduce the coupling loss of light, the mode field diameter of light from the single-core fibers 100 is preferably equal to that of light incident to the cores Cₖ of the multi-core fiber 1. Meanwhile, the GRIN lens SL2 is an optical system that narrows the interval of light. More specifically, the light that has passed through the GRIN lens SL2 has a reduced mode field diameter. Therefore, the GRIN lenses SL1 are preferably formed as an enlarged optical system taking into account the magnification at which the mode field diameter is reduced by the GRIN lens SL2.

Incidentally, the GRIN lenses SL1 and SL2 need not be formed of a plurality of optical members. The GRIN lenses SL1 and SL2 may be made from a medium whose refractive index is adjusted to achieve their respective functions. That is, the GRIN lenses SL1 and SL2 may be each formed of one optical member.

### [Travel of Light]

In the following, a description is given of how light travels through the coupling member 20 of the embodiment with reference to FIG. 5. In the embodiment, an example is described in which light is emitted from the fiber bundle 10.

First, light is emitted from the end surface Ca of the core C provided in each of the single-core fibers 100. The light emitted from the end surface Ca is collimated by corresponding one of the first optical members SL1a, and is incident to corresponding one of the second optical members SL1b. The light incident to the second optical members SL1b is converged based on the refractive index profile of the medium constituting the second optical members SL1b. The light passing through each of the second optical members SL1b forms an image at the imaging point IP as having an enlarged mode field diameter. If the light emitted from the single-core fibers 100 passes through the medium that forms the first optical members SL1a, it is possible to reduce the reflection and the like due to an air layer. Similarly, if the light from the first optical members SL1a passes through the medium that forms the second optical members SL1b, it is possible to reduce the reflection and the like due to an air layer. Accordingly, a decrease in the coupling efficiency can be reduced.

The light passing through the second optical members SL1b is incident to the third optical member SL2a using the imaging point IP as a secondary light source. In this embodiment, the refractive index of each GRIN lens is adjusted so that the imaging point IP is located at the boundary between the GRIN lenses SL1 and SL2.

The light incident to the third optical member SL2a passes through the third optical member SL2a as being collimated based on the refractive index profile of the medium constituting the third optical member SL2a, and incident to the forth optical member SL2b. The light incident to the forth optical member SL2b is converged based on the refractive index profile of the medium constituting the forth optical member SL2b. Rays of the light are incident to the cores Cₖ of the multi-core fiber 1 at narrowed intervals. If the light emitted from the second optical member SL1b passes through the medium that forms the third optical member SL2a, it is possible to reduce the reflection and the like due to an air layer. Similarly, if the light from the third optical member SL2a passes through the medium that forms the forth optical member SL2b, it is possible to reduce the reflection and the like due to an air layer. Accordingly, a decrease in the coupling efficiency can be reduced.

### [Operation and Effect]

Described below are the operation and effects of the embodiment.

According to the embodiment, the first optical system 21 of the coupling member 20 includes the GRIN lenses SL1. The GRIN lenses SL1 are formed of a medium in which the refractive index is adjusted to change the mode field diameter of light from the optical path (the single-core fibers 100). The second optical system 22 of the coupling member 20 includes the GRIN lens SL2. The GRIN lens SL2 is formed of a medium in which the refractive index is adjusted to change the interval of the light with a changed mode field diameter.

Specifically, the GRIN lenses SL1 each include the first optical member SL1a and the second optical member SL1b. The first optical member SL1a collimates light from corresponding one of the single-core fibers 100. The second optical member SL1b converges the light from corresponding one of the first optical members SL1a. The GRIN lens SL2 includes the third optical member SL2a and the fourth optical member SL2b. The third optical member SL2a collimates the light from each of the second optical members SL1b. The fourth optical member SL2b converges the light from the third optical member SL2a.

As described above, each of the GRIN lenses SL1 filled with a predetermined medium changes the mode field diameter of light from corresponding one of the single-core fibers 100. The GRIN lens SL2 filled with a predetermined medium changes the interval of the light with a changed mode field diameter, and guides the light to the cores Cₖ of the multi-core fiber 1. Accordingly, the intervention of an air layer between the fiber bundle 10 and the multi-core fiber 1 can be avoided. That is, with the structure of this embodiment using the GRIN lenses, it is also possible to reduce a decrease in the coupling efficiency upon coupling of the fiber bundle 10 with the multi-core fiber 1.

### Third Embodiment

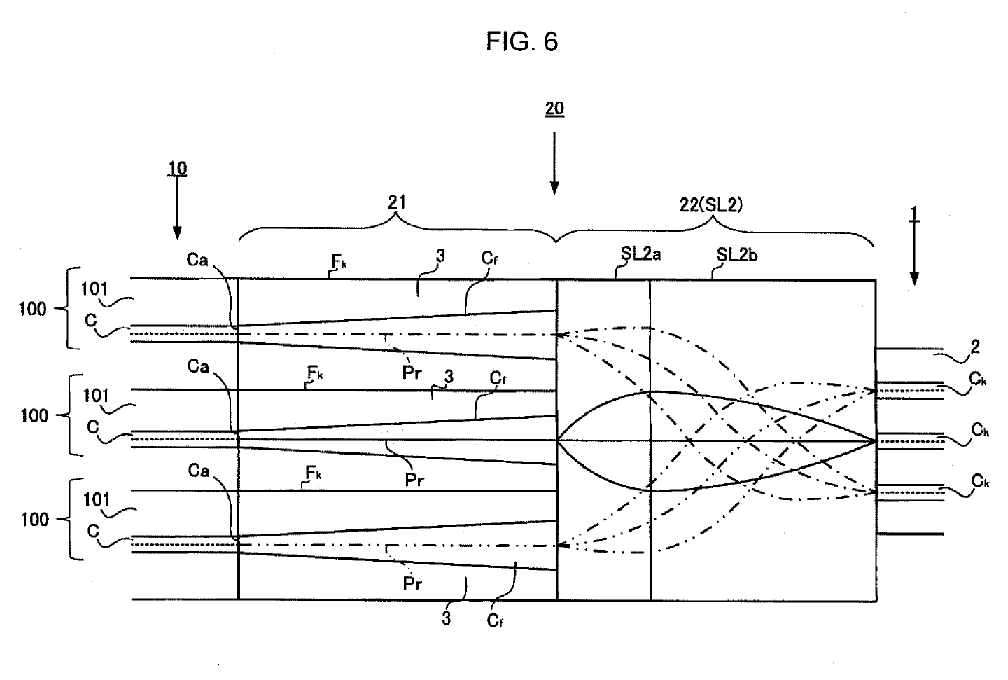

In the following, a description is given of the structure of the coupling member 20 according to a third embodiment with reference to FIG. 6. FIG. 6 is a conceptual diagram of an axial cross-section of the coupling member 20, the fiber bundle 10, and the multi-core fiber 1 of the third embodiment. In this embodiment, an example is described in which a plurality of fibers Fₖ and the GRIN lens SL2 are respectively used for the first optical system 21 and the second optical system 22 that constitute the coupling member 20. Note that, regarding the same structure as in the first and the second embodiments, the detailed description is omitted.

### [Structure of Coupling Member]

The coupling member 20 of the embodiment includes the first optical system 21 and the second optical system 22 as in the first and the second embodiments.

As a medium, the first optical system 21 includes a plurality of fibers Fₖ (k=1 to n). One end of the fibers Fₖ is in contact with the single-core fibers 100. Each of the fibers Fₖ changes the mode field diameter of light from corresponding one of the single-core fibers 100. The fibers Fₖ each include a core C_{f} that transmits light and a cladding 3 that covers the core C_{f}. The diameter of the incident end of the core C_{f} in contact with one of the single-core fibers 100 is substantially the same as the diameter of the core C of the single-core fibers 100. The fibers Fₖ are provided as many as the single-core fibers 100 of the fiber bundle 10.

In addition, in the fibers Fₖ, the core diameter is different between the incident end and the exit end. Specifically, the fibers Fₖ are formed such that the diameter of the core C_{f} increases from the incident end in contact with one of the single-core fibers 100 toward the exit end in contact with the GRIN lens SL2. While light is passing through the core C_{f} of each fiber Fₖ, its mode field diameter increases as the light approaches the exit end.

For example, the fibers Fₖ may be produced as follows: First, heat is applied to a part of a single fiber to cut the fiber. The heat treatment is further applied to the end surface of the fiber, and thereby a fiber Fₖ is obtained that has a core diameter increasing from one end to the other.

In the embodiment, the fibers Fₖ constituting the first optical system 21 and the single-core fibers 100 are separately provided. However, the embodiment is not limited to this example. For example, the single-core fibers 100 may be produced by the method as described above, and thereby formed integrally with the fibers Fₖ. If the single-core fibers 100 are formed integrally with the fibers Fₖ, there is no need for alignment adjustment between the single-core fibers 100 and the fibers Fₖ.

As the second optical system 22 of the embodiment, the same GRIN lens SL2 as in the second embodiment is used. One end of the GRIN lens SL2 is in contact with the exit ends of the fibers Fₖ. The GRIN lens SL2 is formed of a medium in which the refractive index is adjusted to change the interval of light whose mode field diameter has been changed at each of the fibers Fₖ.

### [Travel of Light]

In the following, a description is given of how light travels through the coupling member 20 of the embodiment with reference to FIG. 6. In the embodiment, an example is described in which light is emitted from the fiber bundle 10.

First, light is emitted from the end surface Ca of the core C provided in each of the single-core fibers 100. The light emitted from the end surface Ca is then incident to the GRIN lens SL2 after the mode field diameter has been enlarged in one of the fibers Fₖ. If the light emitted from the single-core fibers 100 passes through the medium that forms the fibers Fₖ (the core C_{f}), reflection and the like due to an air layer does not occur. Accordingly, a decrease in the coupling efficiency can be reduced.

Rays of the light incident to the GRIN lens SL2 are converged based on the refractive index profile of the medium constituting the second optical system 22, and incident to the cores Cₖ of the multi-core fiber 1 at narrowed intervals. If the light from the fibers Fₖ (the core C_{f}) passes through the medium that forms the GRIN lens SL2, it is possible to reduce the reflection and the like due to an air layer. Accordingly, a decrease in the coupling efficiency can be reduced.

### [Operation and Effect]

Described below are the operation and effects of the embodiment.

According to the embodiment, the first optical system 21 of the coupling member 20 includes, as a medium, a plurality of fibers Fₖ each change the mode field diameter of light from corresponding one of the single-core fibers 100. The second optical system 22 includes the GRIN lens SL2. The GRIN lens SL2 is formed of a medium in which the refractive index is adjusted to change the interval of the light whose mode field diameter has been changed.

Thus, each of the fibers Fₖ as a predetermined medium changes the mode field diameter of light incident from corresponding one of the single-core fibers 100. The GRIN lens SL2 that is filled with a predetermined medium changes the interval of the light with a changed mode field diameter, and guides the light to the cores Cₖ of the multi-core fiber 1. Accordingly, the intervention of an air layer can be avoided between the fiber bundle 10 and the multi-core fiber 1. That is, with the structure of this embodiment using the GRIN lens SL2 and the fibers Fₖ whose core diameter varies between the incident end and the exit end, it is also possible to reduce a decrease in the coupling efficiency upon coupling of the fiber bundle 10 with the multi-core fiber 1.

### [Modification 1]

In the above embodiment, to couple the fiber bundle 10 with the multi-core fiber 1 via the coupling member 20, alignment adjustment in the rotation direction is required at the coupling portion of each. Described in this modification is a structure that does not require such alignment adjustment. In the following, a description is given of coupling between the multi-core fiber 1 and the coupling member 20. Note that the same structure can be used for coupling between the coupling member 20 and the fiber bundle 10.

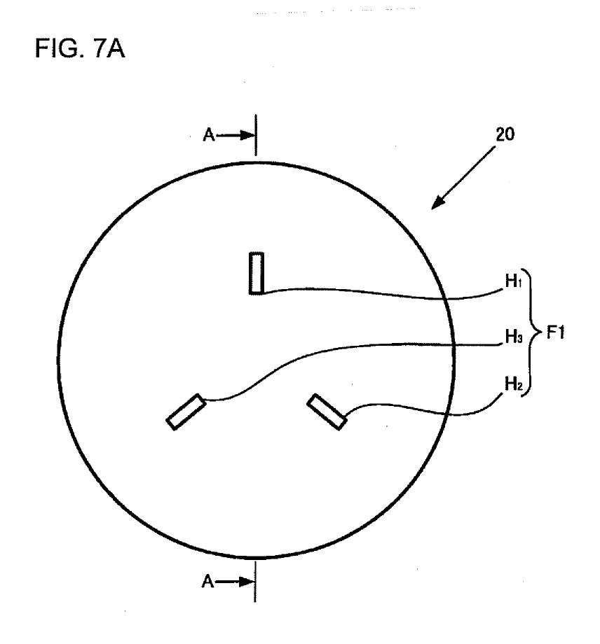

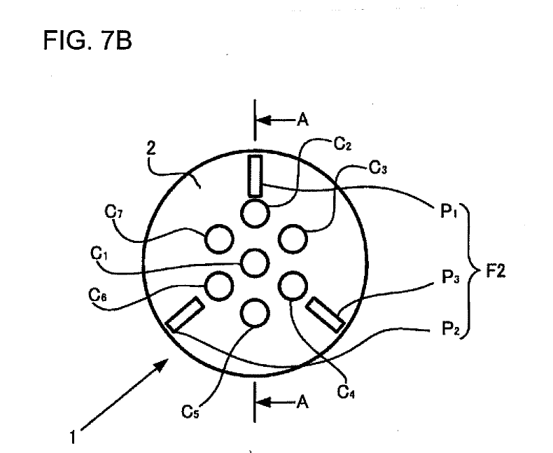

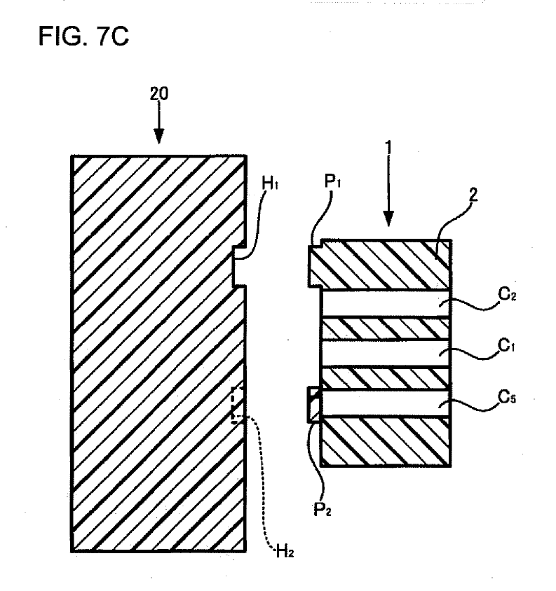

FIG. 7A is a view of an end surface of the coupling member 20. FIG. 7B is a view of an end surface of the multi-core fiber 1. FIG. 7C is a cross-sectional view taken along line A-A in FIGS. 7A and 7B.

As illustrated in FIGS. 7A and 7C, the end surface (the end surface to be coupled with the multi-core fiber 1) of the coupling member 20 is provided with a fitted portion F1. As the fitted portion F1, for example, at least two holes Hₖ (k=1 to n) are provided to the end surface of the coupling member 20. In this modification, three holes H₁ to H₃ are provided.

As illustrated in FIGS. 7B and 7C, the end surface 2a (the end surface to be coupled with the coupling member 20) of the cladding 2 of the multi-core fiber 1 is provided with a fitting portion F2. As the fitting portion F2, for example, at least two projections Pₖ (k=1 to n) are provided to the end surface 2a. In this modification, three projections P₁ to P₃ corresponding to the three holes H₁ to H₃ are provided. The projections Pₖ are formed in about the same size as the holes Hₖ.

As illustrated in FIG. 7C, upon coupling of the coupling member 20 with the multi-core fiber 1, the projections Pₖ are fitted in the holes Hₖ, and thereby the end surface 1b of the multi-core fiber 1 is positioned with respect to the end surface of the coupling member 20. This eliminates the need of alignment adjustment in the rotation direction. Incidentally, the fitting portion F2 may be provided to the end surface of the coupling member 20, while the fitted portion F1 may be provided to the end surface 2a of the cladding 2.

### [Modification 2]

The first optical system 21 and the second optical system 22 of the above embodiments may be provided in any combination. For example, the coupling member 20 may include the GRIN lenses SL1 of the second embodiment as the first optical system 21. The coupling member 20 may also include the both-side telecentric optical system (the convex lens unit 22a, the convex lens unit 22b) of the first embodiment as the second optical system 22.

### EXPLANATION OF SYMBOLS

1 Multi-core fiber
1b End surface
2 Cladding
2a End surface
10 Fiber bundle
20 Coupling member
21 First optical system
21a Convex lens unit
22 Second optical system
22a, 22b Convex lens unit
100 Single-core fiber
101 Cladding
A1, A2 Medium
C, Cₖ Core
Ca, Eₖ End surface

1. An optical fiber coupling member comprising:
one end in contact with a first optical waveguide that includes a bundle of a plurality of single cores covered with a cladding;
another end in contact with a second optical waveguide that includes a plurality of cores each covered with a cladding; and
a predetermined medium that fills between the one end and the other end,
wherein the optical fiber coupling member is configured to
change a mode field diameter of light incident from the one end or the other end,
change an interval of the light the mode field diameter of which has been changed, and
guide the light to either each of the cores of the second optical waveguide or each of the cores of the first optical waveguide, which is located opposite an incident side from which the light is incident.

2. The optical fiber coupling member according to claim 1, further comprising:
a first optical system configured to change the mode field diameter of the light incident from the one end or the other end; and
a second optical system configured to change the interval of the light the mode field diameter of which has been changed.

3. The optical fiber coupling member according to claim 2, wherein
the predetermined medium includes a first medium and a second medium having different refractive indices,
the first optical system and the second optical system are located in the first medium,
the first optical system includes a plurality of lenses which are formed of the second medium and arranged in an array, and
the second optical system includes lenses which are formed of the second medium and constitute a both-side telecentric optical system.

4. The optical fiber coupling member according to claim 3, wherein the second medium that forms the lenses in the first optical system is different from the second medium that forms the lenses in the second optical system.

5. The optical fiber coupling member according to claim 3, wherein the first medium has a refractive index identical to a refractive index of the cores of the first waveguide or a refractive index of the cores of the second waveguide.

6. The optical fiber coupling member according to claim 2, wherein
the first optical system includes a plurality of first GRIN lenses,
the first GRIN lenses are formed of a medium, as the predetermined medium, in which a refractive index is adjusted to change the mode field diameter of the light incident from the one end or the other end,
the second optical system includes a second GRIN lens, and
the second GRIN lens is formed of a medium, as the predetermined medium, in which a refractive index is adjusted to change the interval of the light the mode field diameter of which has been changed.

7. The optical fiber coupling member according to claim 6, wherein
the first GRIN lenses each include
a first optical member configured to collimate light from an optical path, and
a second optical member configured to converge the light from the first optical member, and
the second GRIN lens includes
a third optical member configured to collimate the light from the second optical member, and
a fourth optical member configured to converge the light from the third optical member.

8. The optical fiber coupling member according to claim 2, wherein
the first optical system includes, as the predetermined medium, a plurality of fibers configured to change the mode field diameter of the light incident from the one end or the other end,
the second optical system includes a second GRIN lens, and
the second GRIN lens is formed of a medium, as the predetermined medium, in which a refractive index is adjusted to change the interval of the light the mode field diameter of which has been changed.

9. The optical fiber coupling member according to claim 2, wherein the first optical system and the second optical system are fixed together by an adhesive to be formed integrally.

10. The optical fiber coupling member according to claim 1, further comprising:
a fitting portion provided to an end surface of either or both of the first optical waveguide and the second optical waveguide, and
a fitted portion provided to either or both of the one end and the other end, the fitted portion configured to be fitted in the fitting portion.

11. The optical fiber coupling member according to claim 1, wherein
the first optical waveguide is a fiber bundle including a plurality of single-core fibers as the single cores, and
the second optical waveguide is a multi-core fiber.

12. A manufacturing method of an optical fiber coupling member that includes
a first substrate including a plurality of first members each having one end in contact with a fiber bundle formed of a plurality of single-core fibers and another end provided with a plurality of first recesses, each of which corresponds to one of the single-core fibers,
a second substrate including a plurality of second members each having one end provided with a plurality of second recesses corresponding to the first recesses, and another end provided with a third recess corresponding to the second recesses,
a third substrate including a plurality of third members each having one end provided with a fourth recess corresponding to the third recess, and another end provided with a fifth recess corresponding to the fourth recess, and
a fourth substrate including a plurality of fourth members each having one end provided with a sixth recess corresponding to the fifth recess, and another end in contact with a multi-core fiber, the manufacturing method including:
stacking the first substrate and the second substrate in layers such that the first recesses face the second recesses;
stacking the second substrate and the third substrate in layers such that the third recess faces the fourth recess;
stacking the third substrate and the fourth substrate in layers such that the fifth recess faces the sixth recess;
injecting resin into spaces formed by the first recesses and the second recesses to form first lens units;
injecting resin into a space formed by the third recess and the fourth recess to form a second lens unit;
injecting resin into a space formed by the fifth recess and the sixth recess to form a third lens unit; and
cutting layers of the substrates into individual pieces formed of the first to fourth members, after the first lens units, the second lens unit, and the third lens unit have been fabricated.

13. The optical fiber according to claim 4, wherein the first medium has a refractive index identical to a refractive index of the cores of the first waveguide or a refractive index of the cores of the second waveguide.
